(19) United States
(12) Patent Application Publication
(10) Pub. No.: US 2009/0139328 A1
(43) Pub. Date: Jun. 4, 2009

(54) Packaged micro movable device and method for making the same

(75) Inventors: Hiroaki Inoue, Kawasaki (JP); Fumihiko Nakazawa, Kawasaki (JP); Hiroshi Ishikawa, Kawasaki (JP); Takashi Katsuki, Kawasaki (JP); Takayuki Yamaji, Yokohama-shi (JP)

Correspondence Address: KRATZ, QUINTOS & HANSON, LLP, 1420 K Street, N.W., Suite 400, WASHINGTON, DC, 20005, US

(73) Assignees: FUJITSU LIMITED, Kawasaki (JP); FUJITSU MEDIA DEVICES LIMITED, Yokohama-shi (JP)

(21) Appl. No.: 12/071,862

(22) Filed: Feb. 27, 2008

(30) Foreign Application Priority Data
Feb. 28, 2007 (JP) 2007-048806

(51) Int. Cl. G01P 15/00; B32B 38/00; C23F 1/00; B23K 37/00

(52) U.S. Cl. 73/514.02; 156/250; 216/20; 228/176; 216/17

(57) ABSTRACT

A method is provided for making packaged micro-devices each including a micro movable element, a first packaging member formed with a recess, and a second packaging member formed with another recess. The micro movable element has a movable part. In accordance with the method, a device wafer is prepared for forming a plurality of micromovable elements. A first packaging wafer, formed with a plurality of recesses corresponding in position to the movable parts of the respective movable elements, is bonded to one surface of the device wafer. A second packaging wafer, formed with a plurality of recesses, is bonded to the other surface of the device wafer. The resulting laminate assembly is cut into separate products.

### BACKGROUND OF THE INVENTION

1. Field of the Invention

The present invention relates to packaged micro movable devices such as acceleration sensors and angular velocity sensors. The present invention also relates to methods for making such micro movable devices.

2. Description of the Related Art

In recent years, very small devices produced by micromachining technology have been finding wide application in various technical fields. Those devices, having tiny movable or swingable parts, serve as sensing devices such as angular velocity sensors and acceleration sensors. These sensing devices are used in fields of camera shake control technology for video cameras or mobile telephones equipped with cameras, for example. In addition, the sensing devices can be used for car navigation systems, airbag release timing control systems, and attitude control systems in automobiles and robots.

Miniaturized sensing devices include, for example, a swingable or movable part, a stationary part, a connecting part for connecting the movable part and the stationary part, a driver-electrode pair for driving the movable part, and a detection-electrode pair for detecting the operation or the amount of displacement of the movable part. Such a sensing device has a problem of deteriorated operation performance due to electrode contamination by foreign matters or dirt, or damage caused to the electrode. In order to avoid such electrode contamination or damage, packaging is often performed at a wafer level in manufacturing process of the sensing device. Techniques covering such a packaging process are disclosed in the following patent documents 1 and 2 for example.
Patent Document 1: JP-A-2001-196484
Patent Document 2: JP-A-2006-46995

FIG. 17 shows part of a conventional process through which a packaged sensing device 300 is manufactured.

FIG. 17(a) shows a device wafer 300′, in which a plurality of sensing devices 300 are already formed after a predetermined process. Each sensing device 300 includes a movable part 301 which is swingable, a stationary part 302, a connecting part (not illustrated) for connecting the movable part 301 and the stationary part 302, a driver-electrode pair (not illustrated) for driving the movable part 301, and a detection-electrode pair (not illustrated) for detecting the operation or the amount of displacement of the movable part 301. The movable part 301 is thinner than the stationary part 302. To the device wafer 300′, packaging wafers 303′, 304′ are bonded. In other words, the device wafer 300′ or each of the sensing devices 300 is packaged at a wafer level. The device wafer 300′ which is packaged at a wafer level is then separated as shown in FIG. 17(b) into individual pieces in a dicing step. Through this process, packaged sensing devices 300 each packaged by packaging members 303, 304 are obtained.

In the sensing device 300, a sufficient amount of gaps G, G′ are provided between the movable part 301 and the packaging members 302, 304 so that the movable part 301, which makes a swinging movement when the device is driven will not make contact with the packaging members 303, 304. Each of the parts in each sensing device 300, e.g. the movable part 301 and the stationary part 302, is formed within the device wafer 300′ through etching and other predetermined processes performed to the device wafer 300′ which has a uniform thickness originally. In order to create the gaps G, G′, the device wafer 300′ is etched so as to make the movable part 301 thinner than the stationary part 302 which is bonded to the packaging members 303, 304.

However, according to such a conventional method as the above, relatively large nonuniformity is unavoidable in the thickness of a plurality of movable parts 301 formed in the device wafer 300′. As a result, relatively large nonuniformity is unavoidable among those movable parts 301 obtained from the same single devicewafer 300′, in terms of the inertia of those movable parts 301 in their swinging movement when the devices are in operation. Inertial nonuniformity in the movable part 301 of the sensing device 300 or micro movable device can be a cause of nonuniformity in operational characteristic of the movable part 301, and therefore should be as small as possible. Likewise, inertial nonuniformity in the movable part 301 in the sensing device 300 can be a cause of nonuniformity in the detecting characteristic regarding detection of movement or the amount of displacement of the movable part 301, and therefore should be as small as possible.

### SUMMARY OF THE INVENTION

The present invention has been proposed under the above-described circumstances, and it is therefore an object of the present invention to provide a packaged micro-device that is suitable for reducing operational characteristic nonuniformity of the movable part in the micro movable device.

A first aspect of the present invention provides a method for making a packaged micro-device which includes a micro movable device having a movable part, a first packaging member having a first recess located correspondingly to the movable part, and a second packaging member having a second recess located correspondingly to the movable part. The method includes a first bonding step, a second bonding step and a dicing step. In the first bonding step, a first packaging wafer is bonded to a first surface side of a device wafer from which a plurality of the micro movable elements each having the movable part are to be formed. The device wafer has the first surface and a second surface which faces away from the first surface. The first packaging wafer is provided with a plurality of the first recesses. In the second bonding step, a second packaging wafer is bonded to the second surface side of the device wafer. The second packaging wafer is provided with a plurality of the second recesses. In the dicing step, a laminate assembly which includes the device wafer, the first packaging wafer and the second packaging wafer is cut.

In the first bonding step of the present method described above, the device wafer and the first packaging wafer are bonded together in such a way that each of the first recesses faces or will face the movable part in one of the micro movable devices which are already formed or to be formed in the device wafer. In the second bonding step, the device wafer and the second packaging wafer are bonded together in such a way that each of the second recesses faces the movable part in one of the micro movable devices which are already formed in the device wafer. Through such a first and a second bonding steps as described above, packaging at a wafer level is accomplished. Thereafter, the dicing step is performed to obtain individual pieces, i.e. individual micro movable elements each being in a packaged state.

In the present method, the first packaging wafer which is already formed with the first recesses each providing operation space for the movable part is bonded to the device wafer in the first bonding step, and further, the second packaging wafer which is already formed with the second recesses each providing operation space for the movable part is bonded to the device wafer in the second bonding step. Therefore, there is no need for etching the movable part thereby making the movable part thinner than the stationary part in order to provide a sufficient gap between the movable part and the two packaging members to prevent the movable part from contacting the first or the second packaging members as it makes swinging movement when the device is in operation. If the movable part is made thinner than the stationary part by etching, relatively large nonuniformity is unavoidable in the thickness of the movable part in a plurality of micro movable devices as has been described earlier in relation with a conventional method. The nonuniformity causes inertial nonuniformity in the movable parts, and the inertial nonuniformity can cause undesirable operational characteristic nonuniformity of the movable part. The present method which requires no thinning of the movable part is suitable for reducing inertial nonuniformity in the movable part. The present method which is suitable for reducing inertial nonuniformity in the movable part that swings when the device is in operation is suitable for reducing operational characteristic nonuniformity of the movable part.

Further, the present method does not require any step of thinning the movable part that is formed within a device wafer having a uniform thickness. Thus, the present method is suitable for manufacturing packaged micro-devices at a high yield rate.

In addition, the present method enables packaging at a wafer level during manufacturing process of the micro-device, and therefore is suitable to reduce operation performance deterioration of the movable part caused by dirt attached to the micro-device, or by damage incurred thereto.

The micro movable element of the present invention preferably includes, in addition to the movable part, a stationary part and a connecting part for connecting the stationary part and the movable part. The movable part is swingable. The micro movable element (and hence the micro-device) serves as a sensing device such as an angular velocity sensor or an acceleration sensor. Inertial nonuniformity in the movable part as a part of the sensing device is a cause for detection characteristic nonuniformity which affects detection of movement or the amount of displacement of the movable part. The present method which is suitable for reducing inertial nonuniformity in the movable part is suitable for reducing operational characteristic nonuniformity of the movable part, and in addition, suitable for reducing detection characteristic nonuniformity regarding detection of movement or the amount of displacement of the movable part.

In the method according to the first aspect of the present invention, preferably, the device wafer has a laminate structure including: a first layer having the first surface; a second layer having the second surface; and an intermediate layer between the first and the second layers. With this arrangement, a step of etching the first layer using a predetermined mask pattern as a mask may be performed before the first bonding step. In this case, the etching of the second layer using a predetermined mask pattern as a mask may be performed after the first bonding step and before the second bonding step.

Preferably, the stationary part of the micro movable device includes a terminal portion for external connection. The first packaging member includes an electroconductive portion extending through the first packaging member to be connected with the terminal portion. Such an arrangement as the above allows for electric wires which are electrically connected with the micro movable device and extended out of the package appropriately. With this arrangement, the electroconductive portion penetrating the first packaging member may be formed before the first bonding step. Alternatively, it is possible to make the electroconductive portion after the first bonding step.

Preferably, the first bonding step or the second bonding step or the both may be performed by one of methods such as an anodic bonding method, a direct bonding method, a room-temperature bonding method or an eutectic bonding method.

Preferably, the border between the device wafer and the first packaging wafer and the border between the device wafer and the second packaging wafer may be provided by an insulation film. Such an arrangement as described above prevents undue electric connection between the device wafer or each micro movable device and the first packaging wafer, or between the device wafer or each micro movable device and the second packaging wafer.

Preferably, the first recesses and/or the second recesses may be formed by DRIE, anisotropic wet etching or isotropic wet etching. These methods enable one to make the first recesses and the second recesses properly.

According to a second aspect of the present invention, there is provided a packaged micro-device that includes: a micro movable element having a movable part; a first packaging member including a first recess corresponding in position to the movable part; and a second packaging member including a second recess corresponding in position to the movable part. The micro-device configured in this manner can be appropriately made by the method according to the present invention. The micro movable element may further include, in addition to the movable part, a stationary part, and a connecting part for connecting the movable part to the stationary part so that the movable part is swingable relative to the stationary part. The micro movable element (hence the micro-device) may serve as a sensing device such as an angular velocity sensor and an acceleration sensor.

### BRIEF DESCRIPTION OF THE DRAWINGS

FIG. 1 is a plan view of a packaged micro-device according to the present invention, with some portions omitted.

FIG. 2 is another plan view of the packaged device according to the present invention, with some portions omitted.

FIG. 3 is a sectional view taken in lines III-III in FIG. 1.

FIG. 4 is a sectional view taken in lines IV-IV in FIG.

FIG. 5 is a sectional view taken in lines V-V in FIG. 1.

FIG. 6 is a sectional view taken in lines VI-VI in FIG. 1.

FIG. 7 is a sectional view taken in lines VII-VII in FIG. 1.

FIG. 8 is a sectional view taken in lines VIII-VIII in FIG. 1.

FIG. 9 shows steps in a method for making a packaged device, according to the present invention.

FIG. 10 shows steps following FIG. 9.

FIG. 11 shows steps following FIG. 10.

FIG. 12 shows variations of a packaging member.

FIG. 13 shows variations of another packaging member.

FIG. 14 is a plan view showing a case where eutectic metal pattern is formed.

FIG. 15 shows a case where eutectic bonding method is used to perform a first bonding step.

FIG. 16 shows a variation of the method for making a packaged device.

FIG. 17 shows steps in a conventional method of making a packaged micro-device.

### DETAILED DESCRIPTION OF THE PREFERRED EMBODIMENTS

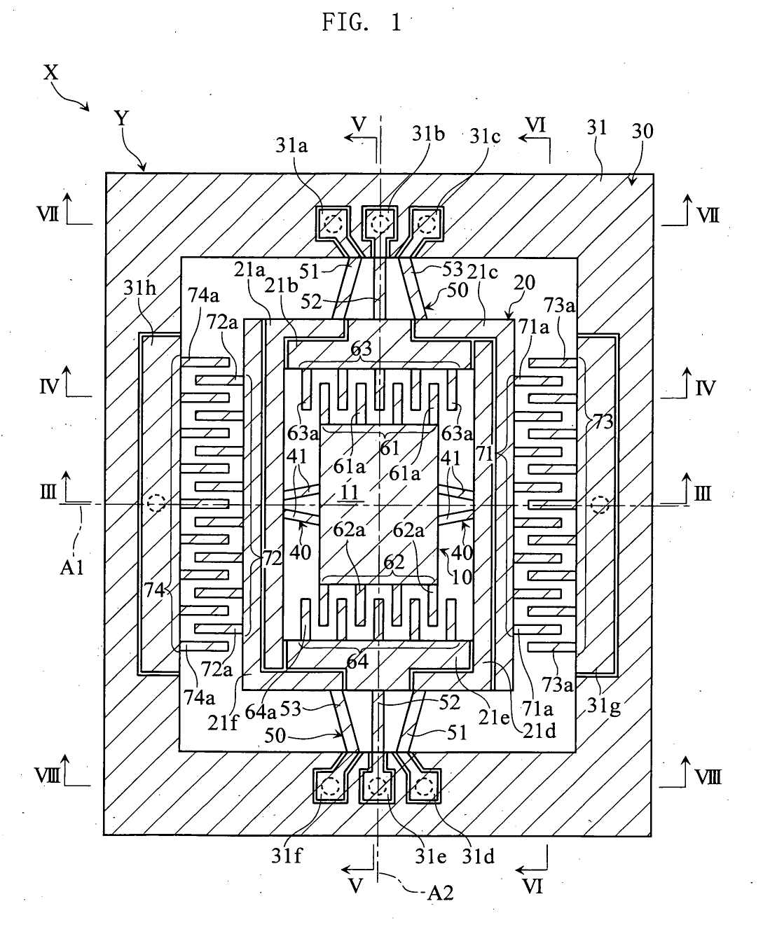

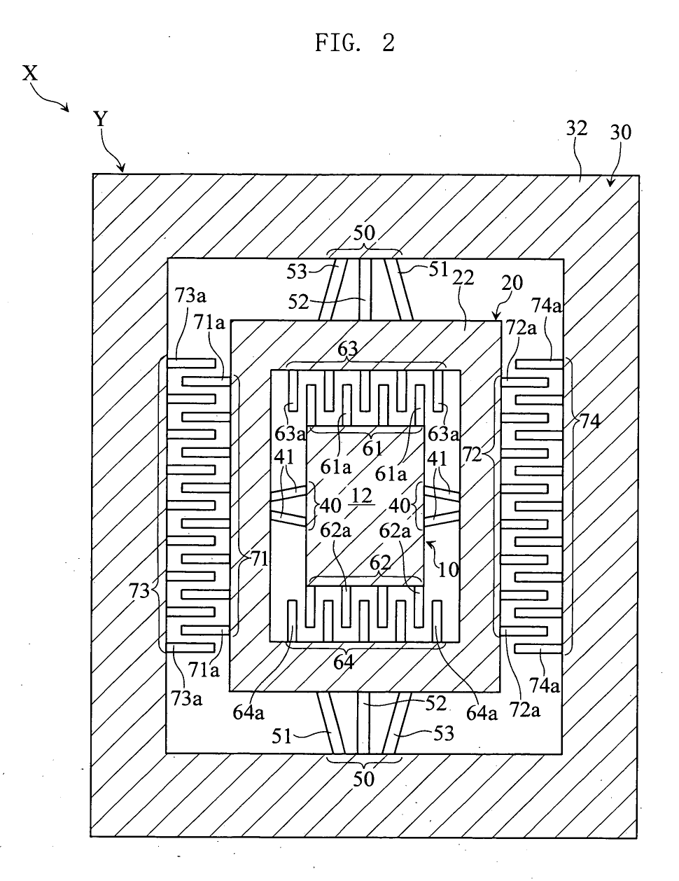

FIG. 1 through FIG. 8 show a packaged micro-device X according to the present invention. FIG. 1 is a plan view of the device X with some portions omitted, and FIG. 2 is another plan view of the device X. FIG. 3 through FIG. 8 are sectional views taken in lines III-III, IV-IV, V-V, VI-VI, VII-VII, and VIII-VIII respectively in FIG. 1.

The packaged device X includes a sensing device Y, a packaging member 81 (not illustrated in FIG. 1), and a packaging member 82 (not illustrated in FIG. 2).

The sensing device Y includes a land 10, an inner frame 20, an outer frame 30, a pair of connecting parts 40, a pair of connecting parts 50, and comb-teeth electrodes 61, 62, 63, 64, 71, 72, 73, 74, and serves as an angular velocity sensor or an acceleration sensor. Also, the sensing device Y is made by means of bulk micromachining technology such as MEMS technology, from an SOI (Silicon On Insulator) substrate wafer. The wafer has a laminate structure including e.g. a first and a second silicon layer, and an insulation layer between the silicon layers. Each silicon layer is doped with impurity and has a predetermined level of electric conductivity. In FIG. 1, the hatched area represents a portion which is made from the first silicon layer and is higher than the insulation layer, projecting toward the viewer of the drawing, whereas in FIG. 2, the hatched area represents a portion which is made from the second silicon layer and is higher than the insulation layer, projecting toward the viewer of the drawing.

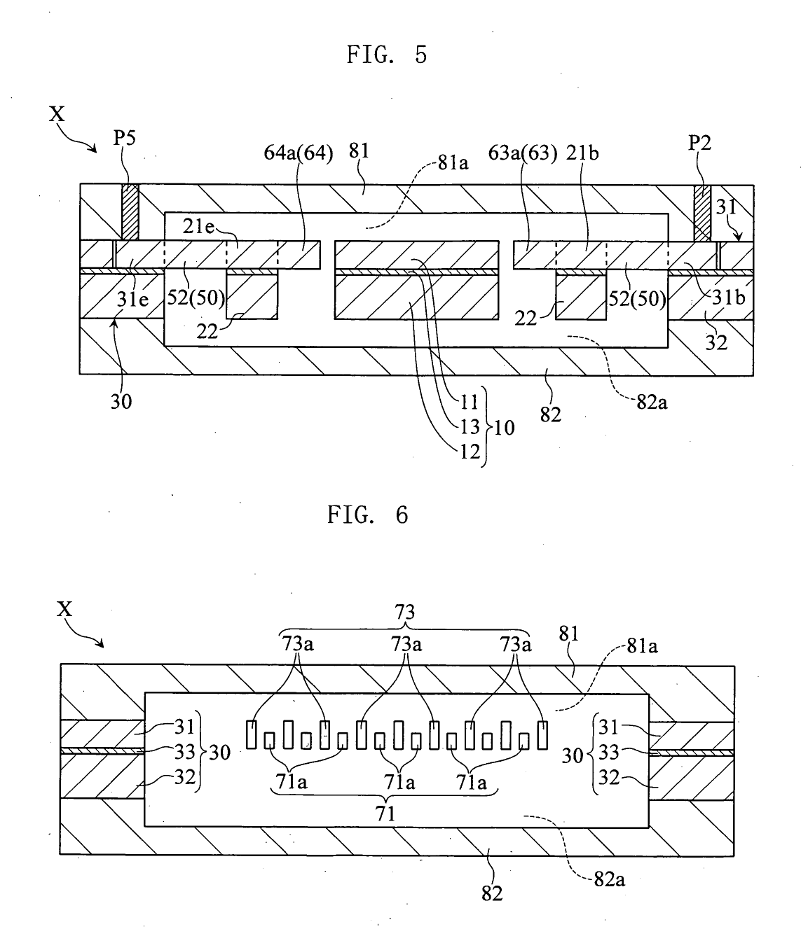

As shown in FIG. 3 and FIG. 5, the land 10 has a laminate structure provided by a first layer portion 11 formed from the first silicon layer, a second layer portion 12 formed from the second silicon layer, and an insulation layer 13 formed from the insulation layer.

As shown in FIG. 3 for example, the inner frame 20 has a laminate structure provided by a first layer portion 21 formed from the first silicon layer, a second layer portion 22 formed from the second silicon layer, and an insulation layer 23 between these. As shown in FIG. 1, the first layer portion 21 includes portions 21a, 21b, 21c, 21d, 21e, and 21f. The portions 21a through 21f are separated from each other via gaps. The inner frame 20 as described above constitutes a movable part of the sensing device Y, together with the land 10.

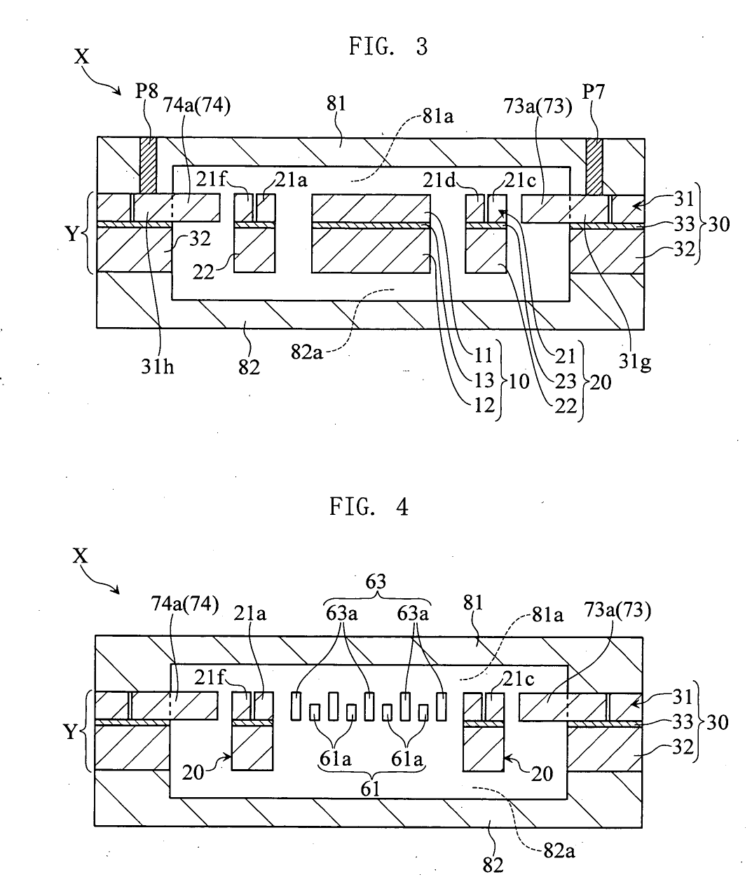

As shown in FIG. 3 and FIG. 4 for example, the outer frame 30 has a laminate structure provided by a first layer portion 31 formed from the first silicon layer, a second layer portion 32 formed from the second silicon layer, and an insulation layer 33 between these. As shown in FIG. 1, the first layer portion 31 includes portions 31a, 31b, 31c, 31d, 31e, 31f, 31g and 31h. The portions 31a through 31h are separated from each other via gaps, and constitute external connection terminals in the sensing device Y. The outer frame 30 as described above constitutes a stationary part of the sensing device Y.

The pair of connecting parts 40 which connect the land 10 and the inner frame 20 are formed from the first silicon layer. Each connecting part 40 is provided by two torsion bars 41. As shown in FIG. 1, each of the torsion bars 41 in one of the pair of connecting parts 40 is connected with the first layer portion 11 of the land 10 as well as with the portion 21a of the inner frame 20, thus providing electrical connection between the first layer portion 11 and the portion 21a. Likewise, each of the torsion bars 41 in the other of the pair of connecting parts 40 is connected with the first layer portion 11 of the land 10 as well as with the portion 21d of the inner frame 20, thus providing electrical connection between the first layer portion 11 and the portion 21d. Such a pair of connecting parts 40 as described define an axis Al for swinging operation of the land 10. Each connecting part 40 which includes two torsion bars 41 each extending from the inner frame 20 to the land 10 with a gradually increasing gap between the two is suitable for reducing unnecessary displacement component in the swinging operation of the land 10.

The pair of connecting parts 50 which connect the inner frame 20 and the outer frame 30 are formed from the first silicon layer. Each connecting part 50 is provided by three torsion bars 51, 52, 53. As shown in FIG. 1, in one of the pair of connecting parts 50, the torsion bar 51 is connected with the portion 21a of the inner frame 20 as well as the portion 31a of the outer frame 30, thus providing electrical connection between the portion 21a and the portion 31a, whereas the torsion bar 52 is connected with the portion 21b of the inner frame 20 as well as the portion 31b of the outer frame 30, thus providing electrical connection between the portion 21b and the portion 31b. Likewise, the torsion bar 53 is connected with the portion 21c of the inner frame 20 as well as the portion 31c of the outer frame 30, thus providing electrical connection between the portion 21c and the portion 31c. In the other of the connecting parts 50, the torsion bar 51 is connected with the portion 21d of the inner frame 20 as well as the portion 31d of the outer frame 30, thus providing electrical connection between the portion 21d and the portion 31d, whereas the torsion bar 52 is connected with the portion 21e of the inner frame 20 as well as the portion 31e of the outer frame 30, thus providing electrical connection between the portion 21e and the portion 31e. Likewise, the torsion bar 53 is connected with the portion 21f of the inner frame 20 as well as the portion 31f of the outer frame 30, thus providing electrical connection between the portion 21f and the portion 31f. Such a pair of connecting parts 50 as described define an axis A2 for swinging operation of the inner frame 20. Each connecting part 50 which includes two torsion bars 51, 53 each extending from the outer frame 30 to the inner frame 20 with a gradually increasing gap between the two is suitable for reducing unnecessary displacement component in the swinging operation of the inner frame 20.

The comb-teeth electrode 61 is formed from the first silicon layer, and is provided by a plurality of electrode teeth 61a extending from the first layer portion 11 of the land 10. As shown in FIG. 1 and FIG. 4 for example, the electrode teeth 61a are parallel to each other.

The comb-teeth electrode 62 is formed from the first silicon layer, and is provided by a plurality of electrode teeth 62a extending from the first layer portion 11 of the land 10 away from the electrode teeth 61a of the comb-teeth electrodes 61. The electrode teeth 62a are parallel to each other.

The comb-teeth electrode 63 is formed from the first silicon layer, opposed to the comb-teeth electrode 61, and provided by a plurality of electrode teeth 63a which extends from the portion 21b of the first layer portion 21 in the inner frame 20. As shown in FIG. 1 and FIG. 4, the electrode teeth 63a are parallel to each other, as well as to the electrode teeth 61a of the comb-teeth electrode 61. The comb-teeth electrode 63 and the comb-teeth electrode 61 as described above constitute a detection-electrode pair in the sensing device Y.

The comb-teeth electrode 64 is formed from the first silicon layer, opposed to the comb-teeth electrode 62, and provided by a plurality of electrode teeth 64a which extends from the portion 21e of the first layer portion 21 in the inner frame 20. The electrode teeth 64a are parallel to each other, as well as to the electrode teeth 62a of the comb-teeth electrode 62. The comb-teeth electrode 64 and the comb-teeth electrode 61 as described above constitute a detection-electrode pair in the sensing device Y.

The comb-teeth electrode 71 is formed from the first silicon layer, and provided by a plurality of electrode teeth 71a which extends from the portion 21c of the first layer portion 21 in the inner frame 20. As shown in FIG. 1 and FIG. 6 for example, the electrode teeth 71a are parallel to each other.

The comb-teeth electrode 72 is formed from the first silicon layer, and provided by a plurality of electrode teeth 72a which extends from the portion 21f of the first layer portion 21 in the inner frame 20. The electrode teeth 72a are parallel to each other.

The comb-teeth electrode 73 is formed from the first silicon layer, opposed to the comb-teeth electrodes 71, and provided by a plurality of electrode teeth 73a which extends from the portion 31g of the first layer portion 31 in the outer frame 30. As shown in FIG. 1 and FIG. 6 for example, the electrode teeth 73a are parallel to each other, as well as to the electrode teeth 71a of the comb-teeth electrode 71. The comb-teeth electrode 73 and the comb-teeth electrodes 71 as described above constitute a driver-electrode pair in the sensing device Y.

The comb-teeth electrode 74 is formed from the first silicon layer, opposed to the comb-teeth electrodes 72, and provided by a plurality of electrode teeth 74a which extends from the portion 31h of the first layer portion 31 in the outer frame 30. The electrode teeth 74a are parallel to each other, as well as to the electrode teeth 72a of the comb-teeth electrode 72. The comb-teeth electrode 74 and the comb-teeth electrodes 72 as described above constitute a driver-electrode pair in the sensing device Y.

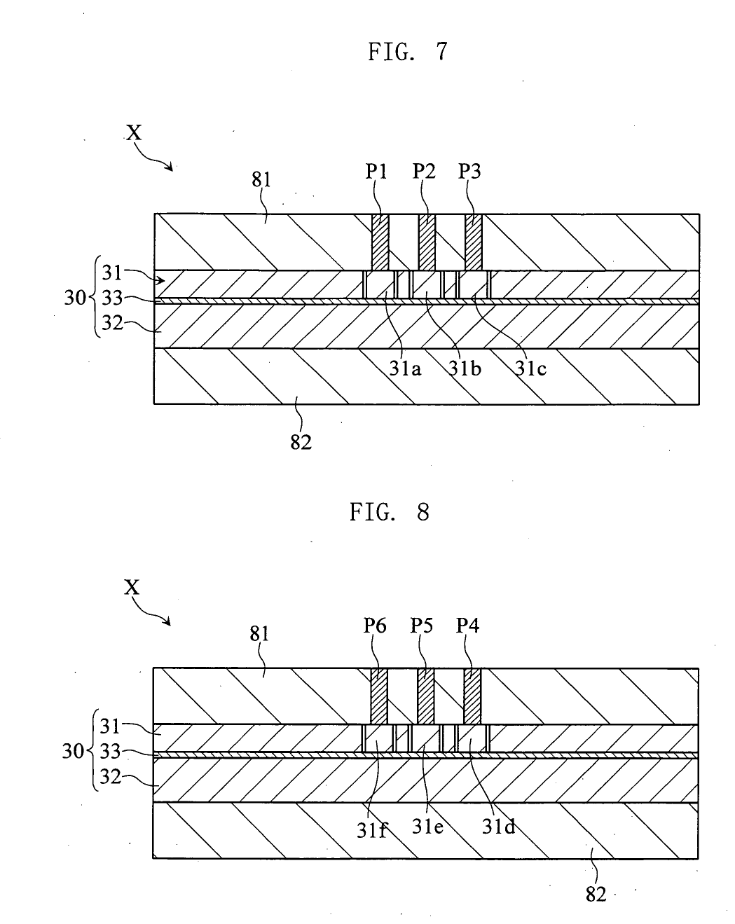

The packaging member 81 is bonded to the first layer portion 31 side of the outer frame 30 in the sensing device Y, and has a recess 81a correspondingly to the movable part of the sensing device Y. As shown in FIG. 3, FIG. 7, and FIG. 8 for example, the packaging member 81 is formed in itself with electrically conductive plugs P1 through P8. As shown in FIG. 7, the conductor plugs P1 through P3 are in contact with the portions 31a, 31b, 31c of the first layer portion 31 in the outer frame 30 respectively, while being exposed to the outside. As shown in FIG. 8, the conductor plugs P4 through P6 are in contact with the portions 31d, 31e, 31f of the first layer portion 31 in the outer frame 30 respectively, while being exposed to the outside. As shown in FIG. 3, the conductor plugs P7, P8 are in contact with the portions 31g, 31h of the first layer portion 31 in the outer frame 30 respectively, while being exposed to the outside. On the other hand, packaging member 82 is bonded to the second layer portion 32 side of the outer frame 30 in the sensing device Y, and has a recess 82a at a location correspondingly to the movable part of the sensing device Y. The sensing device Y is sealed by the packaging members 81, 82 as described above.

In the packaged device X, a sufficient amount of gap is provided between the movable part and the packaging members 81, 82 so that the movable part (the land 10 and the inner frame 20) will not make contact with the packaging members 81, 82 during its swinging operation when the device is in operation.

When the sensing device Y is in operation, the movable part (the land 10 and the inner frame 20) makes a swinging operation around the axis A2 at a predetermined frequency or period. The swinging operation is accomplished by repeating a cycle of voltage application to between the comb-teeth electrodes 71, 73 and voltage application to between the comb-teeth electrode 72, 74. The voltage application to the comb-teeth electrodes 71 can be achieved through the conductor plug P3, the portion 31c in the outer frame 30, the torsion bar 53 of one of the connecting parts 50 and the portion 21c in the inner frame 20. The voltage application to the comb-teeth electrodes 72 can be achieved through the conductor plug P6, the portion 31f in the outer frame 30, the torsion bar 53 of the other of the connecting parts 50 and the portion 21f in the inner frame 20. The voltage application to the comb-teeth electrode 73 can be achieved through the conductor plug P7 and the portion 31g in the outer frame 30. The voltage application to the comb-teeth electrode 74 can be achieved through the conductor plug P8 and the portion 31h in the outer frame 30. In the present embodiment, the swinging operation of the movable part can be accomplished by grounding the comb-teeth electrodes 71, 72, and then repeating a cycle of sequential application of a predetermined electric potential to the comb-teeth electrode 73 and a predetermined electric potential to the comb-teeth electrode 74.

Now, assume that a certain amount of angular velocity or acceleration acts on the sensing device Y or the land 10 while the movable part is being swung as described above. This causes the land 10 to rotate about the axis A1 to a predetermined extent, thereby making a displacement to change the electrostatic capacity between the comb-teeth electrodes 61, 63 and as well as between the comb-teeth electrodes 62, 64. Based on the electrostatic change between the comb-teeth electrodes 61, 63, and the electrostatic change between the comb-teeth electrodes 62, 64, it is possible to detect the amount of rotational displacement of the land 10. Based on the detection result, it is possible to calculate the amount of angular velocity or acceleration acting on the sensing device Y or the land 10.

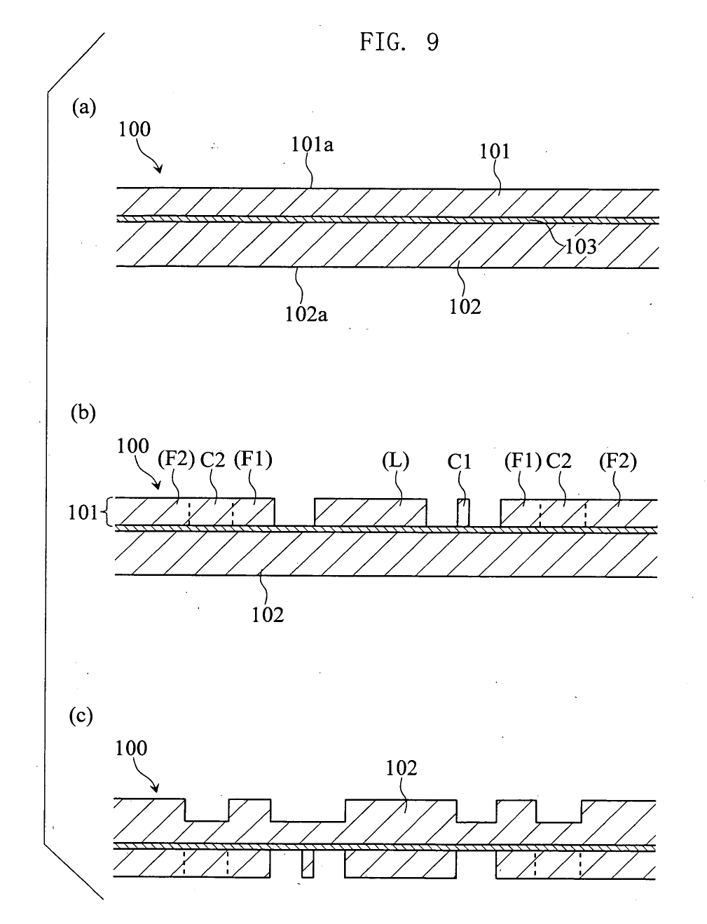

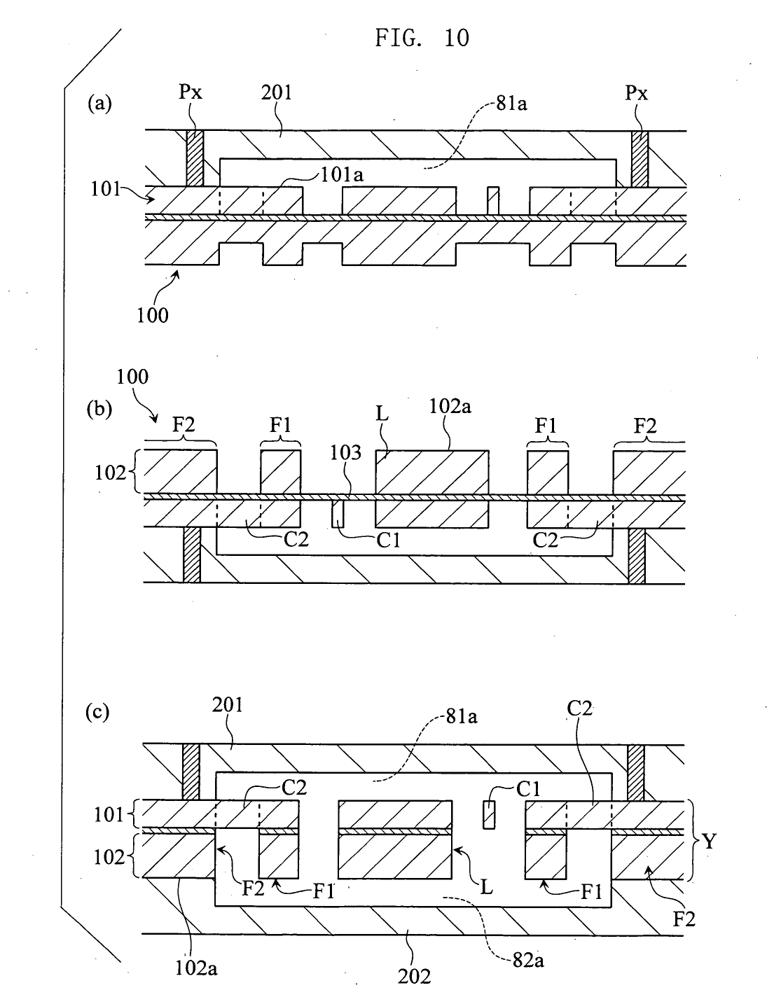

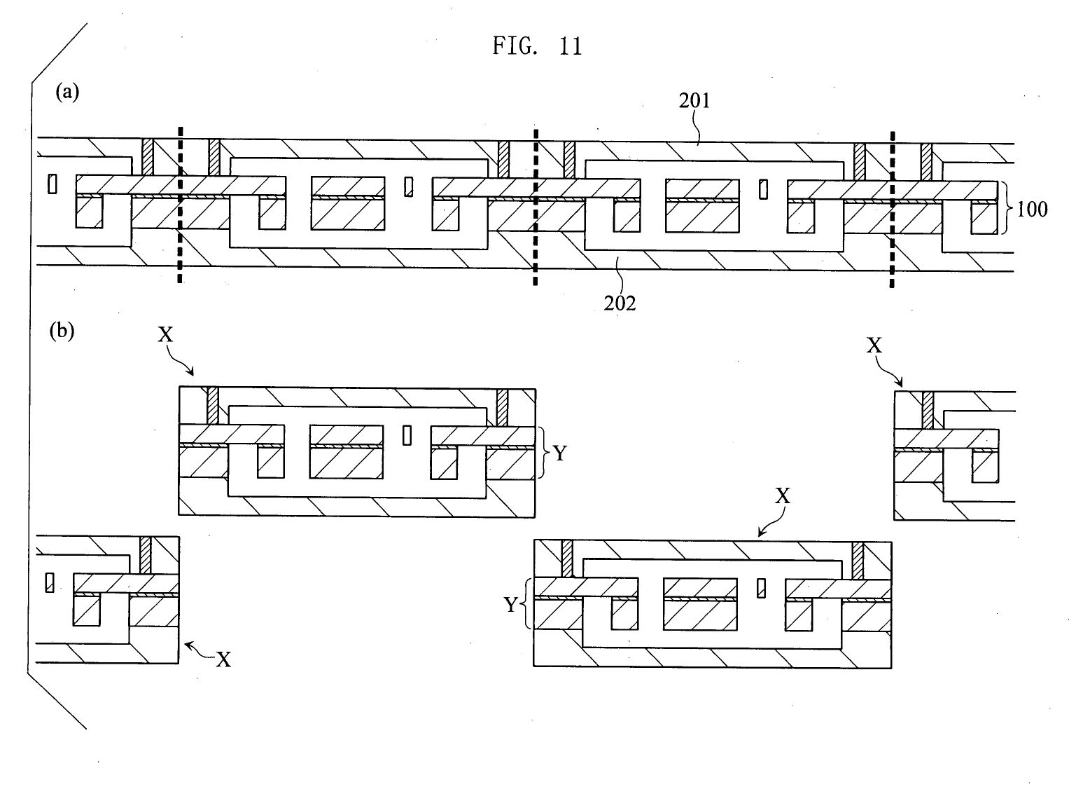

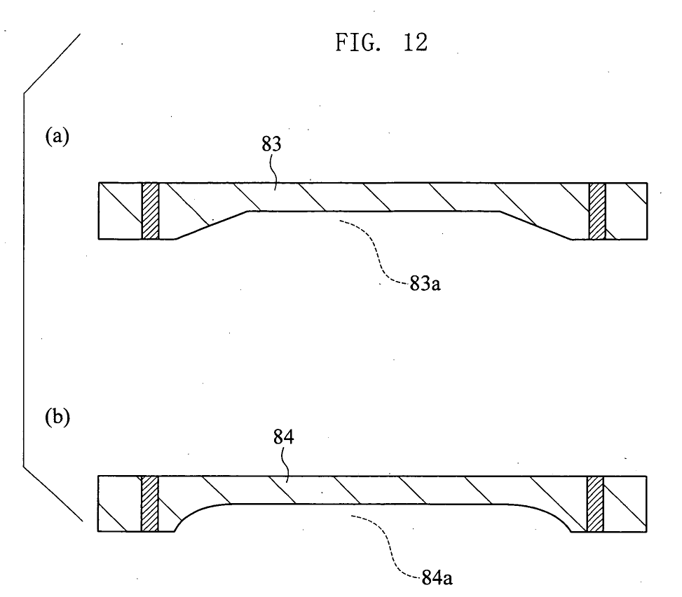

FIG. 9 through FIG. 11 show a method of manufacturing the packaged device X. The method is an example of how the packaged device X can be manufactured through micromachining technology. FIG. 9 and FIG. 10 show a series of views of a conceptual composite section, illustrating various portions included in a single device formation block. FIG. 11 shows a partial section including a plurality of device formation blocks. For the sensing device Y, a formation process will be illustrated mainly through formation of those parts shown in FIG. 10(c) for example, i.e. a land L, an inner frame F1, an outer frame F2 and connecting parts C1, C2. The land L represents part of the land 10. The inner frame F1 represents part of the inner frame 20. The outer frame F2 represents part of the outer frame 30. The connecting part C1 represents the connecting part 40 as a cross section of the torsion bar 41. The connecting part C2 represents the connecting part 50 as a longitudinal section of the torsion bar 51, 52 or 53.

In the manufacture of the packaged device X, first, a device wafer 100 as shown in FIG. 9(a) is prepared. The device wafer 100 is an SOI (Silicon On Insulator) wafer having a laminate structure provided by silicon layers 101, 102, and an insulation layer 103 between the silicon layers 101, 102, and includes a plurality of sensing device formation blocks. The silicon layer 101 is made of a silicon material doped with impurity to render electrical conductivity, and has a surface 101a. The silicon layer 102 is made of a silicon material doped with impurity to render electrical conductivity, and has a surface 102a. The impurity may be a p-type impurity such as B, or an n-type impurity such as P and Sb. The insulation layer 103 is made of silicon oxide for example. The silicon layer 101 has a thickness of e.g. 10 through 100 μm, whereas the silicon layer 102 has a thickness of e.g. 100 through 500 μm, and the insulation layer 103 has a thickness of e.g. 1 through 2 μm. The silicon layers 101, 102 and the insulation layer 103 represent the first and the second layers and the intermediate layer respectively, according to the present invention.

Next, as shown in FIG. 9(b), micromachining is performed to the silicon layer 101, to form part of the land L, part of the inner frame F1, part of the outer frame F2 and connecting parts C1, C2. Specifically, a resist pattern (not illustrated) is formed on the silicon layer 101, and thereafter the silicon layer 101 is subjected to dry etching by means of DRIE (Deep Reactive Ion Etching), using the resist pattern as a mask. In the DRIE operation, good anisotropic etching can be performed by using a Bosch process in which etching and side-wall protection are alternated with each other. The DRIE operation in this step and other steps to be described later may be performed by means of the Bosch process.

Next, as shown in FIG. 9(c), the silicon layer 102 is micromachined. Specifically, a predetermined mask pattern (not illustrated) is formed on the silicon layer 102, and thereafter dry etching by means of DRIE is performed to the silicon layer 102, using the mask pattern as a mask until a midway point of the thickness in the silicon layer 102 is reached. The mask pattern used in this step is provided by e.g. an oxide film pattern and a resist pattern thereon.

Next, as shown in FIG. 10(a), a packaging wafer 201 is bonded to the silicon layer 101 side of the device wafer 100 (first bonding step). The packaging wafer 201 is obtained from a predetermined silicon wafer through micromachining. The micromachined packaging wafer 201 has a plurality of recesses 81a each corresponding to a movable part of the sensing device Y, and a plurality of conductor plugs Px in each of the device formation blocks. The conductor plugs Px represent the conductor plugs P1 through P8. The packaging wafer 201 is formed, in advance, with an insulation film (not illustrated) on a surface which is to face the device wafer 100 (excluding the conductor plug surfaces). The insulation film such as the above can be formed by thermal oxidation method for example. The present bonding step is performed by anodic bonding method, direct bonding method, or room-temperature bonding method. The insulation film which is formed in advance on the surface of packaging wafer 201 enables to prevent undesirable electric connection between different parts of the device wafer 100 via the packaging wafer 201.

The packaging wafer 201 can be made as follows for example: Specifically, first, dry etching (anisotropic dry etching) by means of DRIE is performed to a silicon wafer, using a predetermined mask, to form recesses 81a. Next, through-holes which penetrate the silicon wafer are formed through dry etching by means of DRIE performed to the silicon wafer, using a predetermined mask. Then, the through-holes are filled with electrically conductive material to form the conductor plugs Px.

Continuing with the manufacture of the packaged device X, next, as shown in FIG. 10(b), micromachining is performed to the silicon layer 102, to form part of the land L, part of the inner frame F1 and part of the outer frame F2. Specifically, the silicon layer 102 is subjected to dry etching by means of DRIE, using a predetermined mask pattern.

Next, exposed portions of the insulation layer 103 are removed by predetermined etching, and thereafter, as shown in FIG. 10(c), a packaging wafer 202 is bonded to the silicon layer 102 side of the device wafer 100 (second bonding step). The packaging wafer 202 is obtained from a predetermined silicon wafer through micromachining. The micromachined packaging wafer 202 has a plurality of recesses 82a each corresponding to a movable part of the sensing device Y. The packaging wafer 202 is formed, in advance, with an insulation film (not illustrated) on its surface which is to face the device wafer 100. The insulation film such as the above can be formed by thermal oxidation method for example. The present bonding step is performed by anodic bonding method, direct bonding method, or room-temperature bonding method. The insulation film which is formed in advance on the surface of packaging wafer 202 enables to prevent undesirable electronic connection between different parts of the device wafer 100 via the packaging wafer 202.

The packaging wafer 202 can be made as follows for example: Specifically, dry etching (anisotropic dry etching) by means of DRIE is performed to a silicon wafer, using a predetermined mask, to form recesses 82a. Additionally, if the sealing of the packaged device X need not be air-tight, through-holes may be formed so that inside of the recess 82a in the packaging wafer 202 will communicate with the outside.

Next, as shown in FIG. 11(a) and FIG. 11(b), the laminate structure made of the device wafer 100 and the packaging wafers 201, 202a is cut into pieces (dicing step). Through these steps, it is possible to manufacture the packaged device X according to the present invention.

In the first bonding step described with reference to FIG. 10(a), the device wafer 100 and the packaging wafer 201 are bonded together in such a way that each of the recesses 81a faces the movable part (the land 10 and the inner frame 20) in one of the sensing devices Y to be formed in the device wafer 100. In the second bonding step described with reference to FIG. 10(c), the device wafer 100 and the packaging wafer 202 are bonded together in such a way that each of the recesses 82a faces the movable part (the land 10 and the inner frame 20) in one of the sensing devices Y which have already been formed in the device wafer 100. Through the first and the second bonding steps, packaging at a wafer level can be achieved, and thereafter, the dicing step described with reference to FIG. 11 is performed to obtain, individual pieces (the packaged device X) in which one of the sensing devices Y is packaged.

According to the present method, the packaging wafer 201, which is formed with recesses 81a each providing operation space for the movable part (the land 10 and the inner frame 20) in corresponding one of the sensing devices Y is bonded to the device wafer 100 in the first bonding step, and further, the packaging wafer 202, which is formed with recesses 82a each providing operation space for the movable part (the land 10 and the inner frame 20) in corresponding one of the sensing device Y is bonded to the device wafer 100 in the second bonding step. Therefore, according to the present method, there is no need for etching the movable part thereby making the movable part thinner than the stationary part (the outer frame 30) in order to provide a sufficient gap between the movable part and the packaging members 81, 82 to prevent the movable part from contacting the packaging members 81, 82 when it swings during operation of the device. If the movable part is made thinner than the stationary part (the outer frame 30) by etching, relatively large nonuniformity is unavoidable in the thickness of the movable parts in a plurality of micro movable devices as has been described earlier in relation with a conventional method. The nonuniformity causes inertial nonuniformity in the movable parts, and the inertial nonuniformity can cause undesirable operational nonuniformity of the movable parts. The present method, which requires no thinning of the movable part, is suitable for reducing inertial nonuniformity in the movable part. The present method which is suitable for reducing inertial nonuniformity in the movable part that swings when the device is in operation, is suitable for reducing operational nonuniformity of the movable part. Also, inertial nonuniformity of the movable part as a part of the sensing device is a cause for detection characteristic nonuniformity which affects detection of movement or the amount of displacement of the movable part. The present method which is suitable for reducing inertial nonuniformity in the movable part is suitable for reducing operational nonuniformity of the movable part, and in addition, for reducing detection characteristic nonuniformity which relates to detection of movement or the amount of displacement of the movable part.

Further, the present method does not require any step of thinning the movable part (the land 10 and the inner frame 20) which is formed within a device wafer 100 that has a uniform thickness originally. Thus, the present method is suitable for manufacturing sensing devices Y at a high yield rate.

In addition, the present method enables packaging at a wafer level, and therefore is suitable to reduce operation performance deterioration of the movable part caused by dirt attached to the micro movable device or sensing device Y, or by damage incurred thereto.

FIG. 12(a) shows a packaging member 83 as a variation of the packaging member 81. The packaging member 83 includes a recess 83a. The recess 83a is formed in the silicon wafer by means of anisotropic wet etching performed with the use of a predetermined mask. The etchant for this wet etching may be KOH or TMAH. In the first bonding step which was described with reference to FIG. 10(a), a packaging wafer formed with a plurality of packaging members 83 may be used in place of the packaging wafer 201 formed with a plurality of packaging members 83, for bonding onto the silicon layer 101 side of the device wafer 100.

FIG. 12(b) shows a packaging member 84 as a variation of the packaging member 81. The packaging member 84 includes a recess 84a. The recess 84a is formed in the silicon wafer by means of isotropic wet etching performed with the use of a predetermined mask. The etchant for this wet etching may be a solution mix containing HF, HNO₃, and CH₃COOH. In the first bonding step which was described with reference to FIG. 10(a), a packaging wafer formed with a plurality of packaging members 84 may be used in place of the packaging wafer 201, for bonding onto the silicon layer 101 side of the device wafer 100.

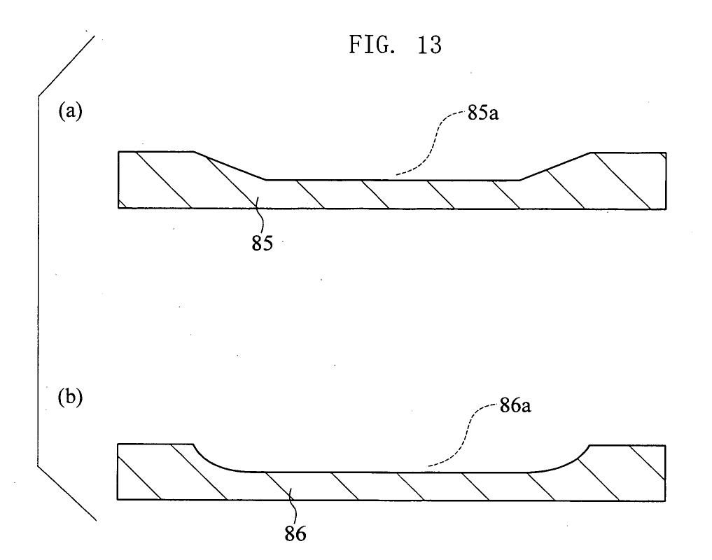

FIG. 13(a) shows a packaging member 85 as a variation of the packaging member 82. The packaging member 85 includes a recess 85a. The recess 85a is formed in the silicon wafer by means of anisotropic wet etching performed with the use of a predetermined mask. The etchant for this wet etching may be KOH or TMAH. If the sealing of the packaged device X need not be air-tight, through-holes may be formed so that inside of the recess 85a will communicate with the outside. In the second bonding step which was described with reference to FIG. 10(c), a packaging wafer formed with a plurality of packaging members 85 may be used in place of the packaging wafer 202 which is formed with a plurality of packaging members 82, for bonding onto the silicon layer 102 side of the device wafer 100.

FIG. 13(b) shows a packaging member 86 as a variation of the packaging member 82. The packaging member 86 includes a recess 86a. The recess 86a is formed in the silicon wafer by means of isotropic wet etching performed with the use of a predetermined mask. The etchant for this wet etching may be a solution mix containing HF, HNO₃, and CH₃COOH. If the sealing of the packaged device X need not be air-tight, through-holes may be formed so that inside of the recess 86a will communicate with the outside. In the second bonding step which was described with reference to FIG. 10(c), a packaging wafer formed with a plurality of packaging members 86 may be used in place of the packaging wafer 202, for bonding onto the silicon layer 102 side of the device wafer 100.

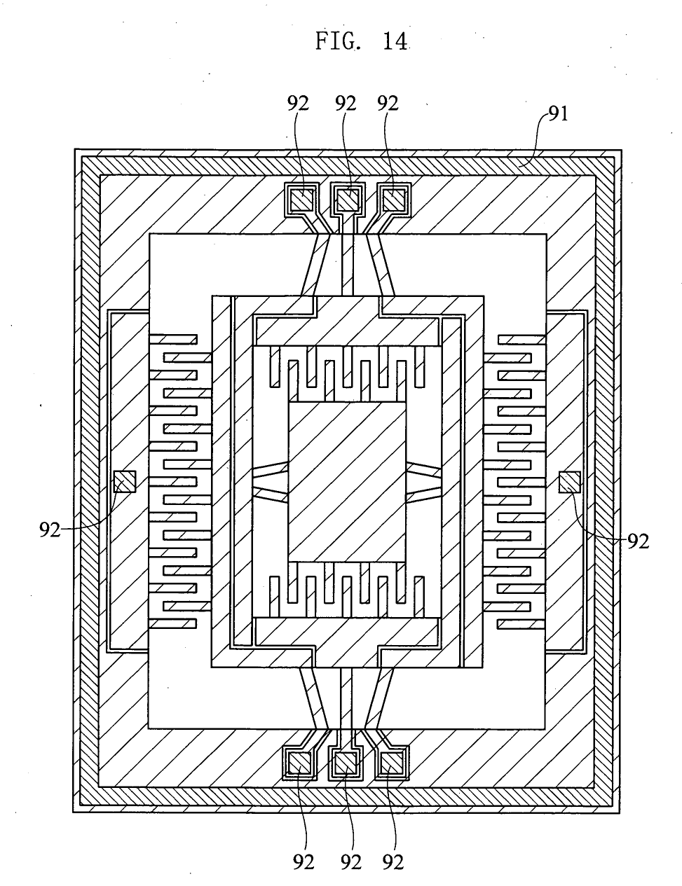

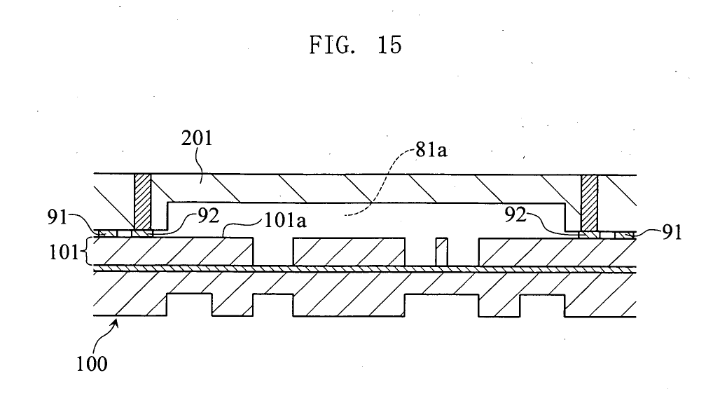

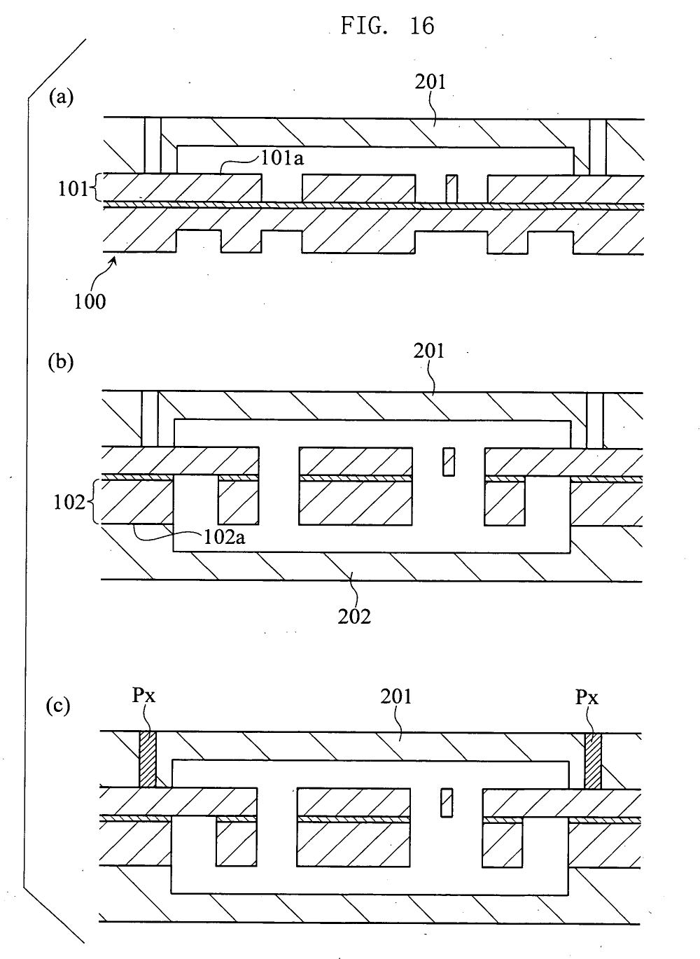

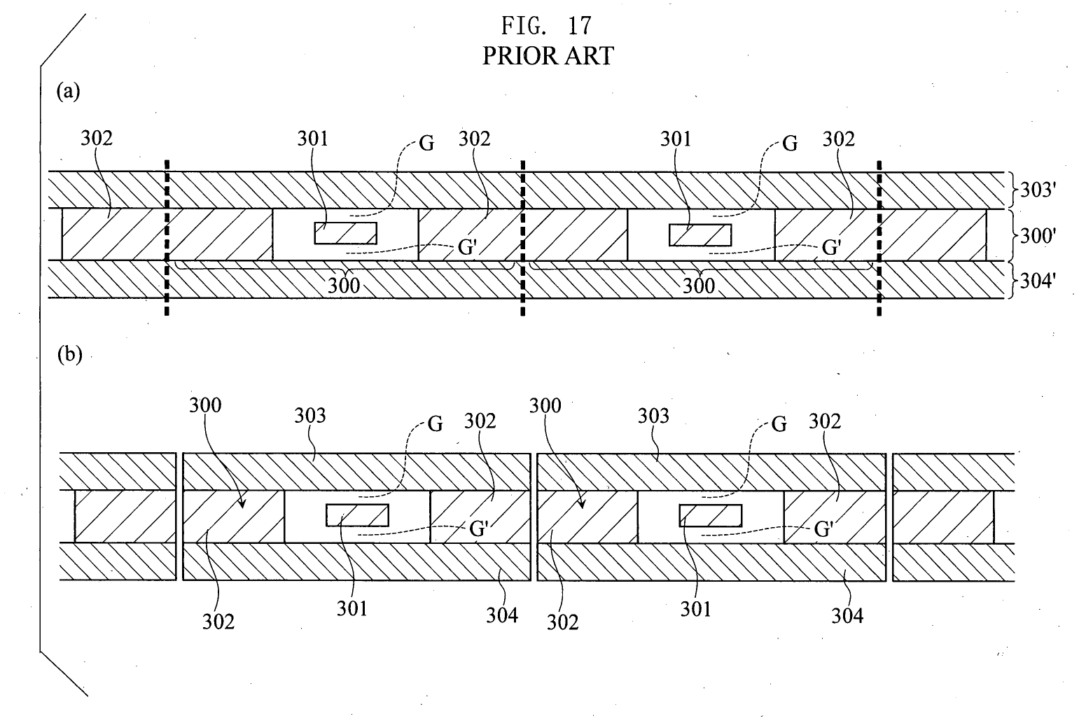

The first bonding step in the above-described manufacturing method may be performed by eutectic bonding method. If eutectic bonding method is used in the first bonding step, a eutectic metal pattern 91 as shown in FIG. 14 is formed in advance on the silicon layer 101 of the device wafer 100. The eutectic metal pattern 91 is formed of Au for example. In addition, electrode pads 92 as shown in FIG. 14 are formed in advance on the silicon layer 101 of the device wafer 100. The electrode pads 92 are formed of Au for example and to be bonded to conductor plugs P1 through P8. Then, in the first bonding step, the device wafer 100 and the packaging wafer 201 are pressed to fit together as shown in FIG. 15, while being heated at a predetermined temperature, thereby achieving a bond between the device wafer 100 and the packaging wafer 201 by eutectic between silicon and Au.

In the first bonding step of the above-described manufacturing method, a packaging wafer 201 as shown in FIG. 16(a), which has not yet formed with conductor plugs Px may be bonded to the silicon layer 101 side of the device wafer 100. If such a step is used, the second bonding step is performed as shown in FIG. 16(b), and then the conductor plugs Px are formed as shown in FIG. 16(c) by filling the through-holes in the packaging wafer 201 with electrically conductive material. Thereafter, the dicing step is performed as has been described earlier with reference to FIG. 11. Manufacture of the packaged device X according to the present invention is also possible by such a method as described above.

1. A method for making packaged micro-devices each comprising a micro movable element having a movable part, a first packaging member formed with a first recess corresponding in position to the movable part, and a second packaging member formed with a second recess corresponding in position to the movable part, the method comprising:
a first bonding step for bonding a first packaging wafer to a device wafer, the first packaging wafer being formed with a plurality of first recesses, the device wafer used for forming a plurality of micro movable elements and including a first surface and a second surface opposite to the first surface, the bonding of the first packaging wafer being performed with respect to the first surface of the device wafer;
a second bonding step for bonding a second packaging wafer to the second surface of the device wafer, the second packaging wafer being formed with a plurality of second recesses; and
a dicing step for cutting a laminate assembly including the device wafer, the first packaging wafer and the second packaging wafer.

2. The method according to claim 1, wherein each of the micro movable elements further includes, in addition to the movable part, a stationary part and a connecting part for connecting the movable part to the stationary part, the movable part being swingable.

3. The method according to claim 1, wherein each of the micro movable elements serves as an angular velocity sensor or an acceleration sensor.

4. The method according to claim 1, further comprising an etching processing step performed before the first bonding step, wherein the the device wafer has a laminate structure including a first layer including said first surface, a second layer including said second surface, and an intermediate layer between the first and the second layers, wherein the etching processing step comprises etching of the first layer by using a mask pattern as a mask.

5. The method according to claim 4, further comprising an additional etching processing step performed after the first bonding step and before the second bonding step, wherein the additional etching processing step comprises etching of the second layer by using a mask pattern as a mask.

6. The method according to claim 1, wherein each of the micro movable elements includes a terminal portion, the first packaging member including an electroconductive portion extending through the first packaging member to be connected with the terminal portion.

7. The method according to claim 6, wherein the electroconductive portion is made in the first packaging member before the first bonding step is performed.

8. The method according to claim 6, wherein the electroconductive portion is made in the first packaging member after the first bonding step is performed.

9. The method according to claim 1, wherein at least one of the first bonding step and the second bonding step is performed by one of an anodic bonding method, a direct bonding method, a room-temperature bonding method or an eutectic bonding method.

10. The method according to claim 1, wherein one of a border between the device wafer and the first packaging wafer and a border between the device wafer and the second packaging wafer is provided with an insulation film.

11. The method according to claim 1, wherein the first recesses are formed by DRIE, anisotropic wet etching or isotropic wet etching.

12. The method according to claim 1, wherein the second recesses are formed by DRIE, anisotropic wet etching or isotropic wet etching.

13. A packaged micro-device comprising:
a micro movable element including a movable part;
a first packaging member including a first recess corresponding in position to the movable part; and
a second packaging member including a second recess corresponding in position to the movable part.
